(19) United States
(12) Patent Application Publication
(10) Pub. No.: US 2017/0008650 A1
(43) Pub. Date: Jan. 12, 2017

(54) ATTITUDE ESTIMATION METHOD AND SYSTEM FOR ON-ORBIT THREE-DIMENSIONAL SPACE OBJECT UNDER MODEL RESTRAINT

(71) Applicant: HUAZHONG UNIVERSITY OF SCIENCE AND TECHNOLOGY

(72) Inventors: Tianxu ZHANG, Wuhan, Hubei (CN); Liangliang WANG, Wuhan, Hubei (CN); Gang ZHOU, Wuhan, Hubei (CN); Ming LI, Wuhan, Hubei (CN); Weidong YANG, Wuhan, Hubei (CN); Kuan LIU, Wuhan, Hubei (CN); Yayun ZHENG, Wuhan, Hubei (CN)

(21) Appl. No.: 15/106,690

(22) PCT Filed: Sep. 2, 2014
(86) PCT No.: PCT/CN2014/085717

§ 371 Date: Jun. 20, 2016

(30) Foreign Application Priority Data
Dec. 28, 2013 (CN) 201310740553.6

(51) Int. Cl. B64G 3/00; G06K 9/62; G06K 9/00; G06K 9/46; G01C 21/24; G01C 21/20

(52) U.S. Cl. CPC B64G 3/00; G01C 21/24; G01C 21/20; G06K 9/00201; G06K 9/4604; G06K 9/6202

(57) ABSTRACT

An attitude estimation method for an on-orbit three-dimensional space object comprises an offline feature library construction step and an online attitude estimation step. The offline feature library construction step comprises: according to a space object three-dimensional model, acquiring multi-viewpoint characteristic views of the object, and extracting geometrical features therefrom to form a geometrical feature library, where the geometrical features comprise an object main body height-width ratio, an object longitudinal symmetry, an object horizontal symmetry, and an object main-axis inclination angle. The online attitude estimation step comprises: preprocessing an on-orbit object image to be tested and extracting features, and matching the extracted features in the geometrical feature library, where an object attitude characterized by a characteristic view corresponding to a matching result is an attitude estimation result. A dimension scale and position relationship between various components of an object are accurately acquired in a three-dimensional modeling stage, thereby ensuring subsequent relatively high matching precision. An attitude estimation system for an on-orbit three-dimensional space object is also provided.

### TECHNICAL FIELD

The present invention belongs to the interdisciplinary field of space technology and pattern recognition, and more particularly to an attitude estimation method and system for an on-orbit three-dimensional space object, which is applicable to satellites, space aircrafts, and the like.

### BACKGROUND ART

A large quantity of space objects such as communication satellites and resource satellites launched around the world can be used in application scenarios such as network communication, remote sensing, and geodesy. For ground-based optoelectronic observation on these space objects, it is essential in this type of system to analyze and judge attitudes thereof. Because a spatial resolution of a ground-based telescope system is limited and the atmospheric environment has random interference for long-distance optical imaging, a phenomenon of a blurred object boundary occurs easily in an image acquired by a ground-based sensor. When the boundary an imaged object is blurred, the accuracy of conventional attitude estimation and three-dimensional reconstruction algorithms based on feature point matching usually decreases rapidly as a blurring level of the object increases. Attitude estimation is to calculate, from a projection image of an object acquired by a two-dimensional camera coordinate system, a pitching angle α and a yaw angle β of the object in a three-dimensional object coordinate system, and a pair of angle values (α,β) correspond to one attitude. The accuracy of attitude estimation is highly significant for analysis of component dimensions and relative position relationships of components of space objects, and functional attributes of the space objects. Therefore, it is necessary to carry out research on a robust attitude estimation algorithm under a condition of ground-based long-distance optical imaging.

Scholars around the world have conducted detailed research on attitude estimation algorithms for space objects in this type of imaging and have obtained related results. For example, “Method of Measuring Attitude Based on Inclined Angle of Segment Between Feature Points” of Zhao Rujin, Zhang Qiheng, and Xu Zhiyong is published on ACTA PHOTONICA SINICA (February, 2010, Vol. 39, No. 2). Research is conducted on an iteration solution method for a 3-dimensional attitude of an object based on inclination angle information between object feature points. The method is applicable to solving an object attitude under conditions of a long-distance weak-perspective imaging object and unknown parameters inside a camera. However, the precision of the algorithm severely depends on the precision of edges, straight lines, and angular points extracted. When an iteration initial value is deviated from an actual attitude by a relatively large error, the algorithm requires a relatively large number of iterations, so that a computing quantity is large, and a condition in which iterations do not converge may occur. In ground-based long-distance optical imaging, an object boundary may be blurred easily, and positioning precision of a feature point is affected. Therefore, the precision of the algorithm is undesirable. “Mono-view image attitude determination method based on proportions of feature points of object” of Wang Kunpeng, Zhang Xiaohu, and Yu Qifeng on Journal of Applied Optics (November, 2009, Vol. 30, No. 6) proposes a mono-view attitude determination method for a recorded live image, in which an object attitude parameter is obtained by means of an iteration solution using a system of nonlinear equations using proportion information of coordinates of object feature points and position and attitude parameter relationships between an object imaging model and a coordinate system. The algorithm has high solving precision and desirable robustness; however, marking points on an object need to be known in advance, so that the algorithm is not suitable for attitude solving of non-cooperative objects and unmarked objects, and therefore has undesirable adaptability. In “Random sample consensus: a paradigm for model fitting with applications to image analysis and automated cartography” of FISHL E R M A, FISHL E R M A, BOLL E S R C. ([J]. Communications of the ACM, 1981, 24 (6):381-395), a large quantity of point pairs are extracted on an object and a projection image of the object, and a manner of consistent cross validation is used to select the fewest feature points to perform three-dimensional reconstruction of an attitude. The algorithm needs to extract a large quantity of feature point pairs and has a large computing quantity, and when the feature point pairs have a matching error, the algorithm has a great error. The foregoing research results all propose respective solutions for special cases of such type of problems, and each solution has its own algorithm characteristic. However, the algorithms all have problems such as a large computing quantity, undesirable precision or low adaptability.

### SUMMARY

To resolve problems of a large computing quantity, undesirable precision, or low adaptability of the existing methods, the present invention provides an attitude estimation method and system for an on-orbit three-dimensional space object, in which three-dimensional space attitude information of an object can be effectively estimated from a two-dimensional image of the space object, precision is high, a computing quantity is small, and adaptability is high.

An attitude estimation method for an on-orbit three-dimensional space object includes an offline feature library construction step and an online attitude estimation step, where

the offline feature library construction step specifically includes:

(A1) acquiring, according to a space object three-dimensional model, multi-viewpoint characteristic views of the object for characterizing various attitudes of the space object; and

(A2) extracting geometrical features from each space object multi-viewpoint characteristic view to form a geometrical feature library, where the geometrical features include an object main body height-width ratio T_{i,1}, an object longitudinal symmetry T_{i,2}, an object horizontal symmetry T_{i,3}, and an object main-axis inclination angle T_{i,4}, where the object main body height-width ratio T_{i,1} refers to a height-width ratio of an minimum bounding rectangle of the object; the object longitudinal symmetry T_{i,2} refers to a ratio of an area of the upper-half portion of the object to an area of the lower-half portion of the object within a rectangular region enclosed by the minimum bounding rectangle of the object; the object horizontal symmetry T_{i,3} refers to a ratio of an area of the left-half portion of the object to an area of the right-half portion of the object within the rectangular region enclosed by the minimum bounding rectangle of the object; and the object main-axis inclination angle T_{i,4} refers to an included angle between an object cylinder-body main axis and a view horizontal direction of a characteristic view; and

the online attitude estimation step specifically includes:

(B1) preprocessing an on-orbit space object image to be tested;

(B2) extracting features from the image to be tested after preprocessing, where the features are the same as the features extracted in Step (2); and

(B3) matching the features extracted from the image to be tested in the geometrical feature library, where a space object attitude characterized by a characteristic view corresponding to a matching result is an object attitude in the image to be tested.

Furthermore, a manner of extracting the feature, the object main body height-width ratio T_{i,1} includes:

(A2.1.1) obtaining a threshold Tᵢ by using a threshold criterion of a maximum between-cluster variance for a characteristic view Fᵢ, setting a pixel gray value fᵢ(x, y) greater than the threshold Tᵢ in the characteristic view Fᵢ as 255, and setting a pixel gray value fᵢ(x, y) less than or equal to the threshold Tᵢ as zero, thereby obtaining a binary image Gᵢ, where Gᵢ is a pixel matrix whose width is n and height is m, and gᵢ(x, y) is a pixel gray value at a point (x,y) in Gᵢ;

(A2.1.2) scanning the binary image Gᵢ in an order from top to bottom and from left to right, if a current point pixel value gᵢ(x, y) is equal to 255, recording a current pixel horizontal coordinate x=Topj, and a vertical coordinate y=Topi, and stopping scanning;

(A2.1.3) scanning the binary image Gᵢ in an order from bottom to top and from left to right, if a current point pixel value gᵢ(x, y) is equal to 255, recording a current pixel horizontal coordinate x=Bntj, and a vertical coordinate y=Bnti, and stopping scanning;

(A2.1.4) scanning the binary image Gᵢ in an order from left to right and from top to bottom, if a current point pixel value gᵢ(x, y) is equal to 255, recording a current pixel horizontal coordinate x=Leftj, and a vertical coordinate y=Lefti, and stopping scanning;

(A2.1.5) scanning the binary image Gᵢ in an order from right to left and from top to bottom, if a current point pixel value gᵢ(x, y) is equal to 255, recording a current pixel horizontal coordinate x=Rightj, and a vertical coordinate y=Righti, and stopping scanning; and

(A2.1.6) defining the object main body height-width ratio of the characteristic view Fᵢ as

$${T}_{i , 1} = \frac{{H}_{i}}{{W}_{i}} ,$$

where Hᵢ=|Topi−Bnti|, Wᵢ=|Leftj−Rightj|, and the symbol |V| represents an absolute value of the variable V.

Furthermore, a manner of extracting the feature, the object longitudinal symmetry T_{i,2} includes:

(A2.2.1) calculating a horizontal coordinate Cᵢₓ=└(Leftj+Rightj)/2┘ and a vertical coordinate Cᵢ=└(Topi+Bnti)/2┘ of a central point of the characteristic view Fᵢ, where the symbol └V┘ represents taking an integral part for the variable V;

(A2.2.2) counting the number of pixel points whose gray value is 255 within a region where 1≦horizontal coordinate x≦n and 1≦vertical coordinate y≦C_{iy} in the binary image Gᵢ, that is, the area STᵢ of the upper-half portion of the object of the characteristic view Fᵢ;

(A2.2.3) counting the number of pixel points whose gray value is 255 within a region where 1≦horizontal coordinate x≦n and C_{iy}+1≦vertical coordinate y≦m in the binary image Gᵢ, that is, the area SDᵢ of the lower-half portion of the object of the characteristic view Fᵢ; and

(A2.2.4) calculating the object longitudinal symmetry

$${T}_{i , 2} = \frac{{ST}_{i}}{{SD}_{i}}$$

of the characteristic view Fᵢ.

Furthermore, a manner of extracting the feature, the object horizontal symmetry T_{i,3} includes:

(A2.3.1) counting the number of pixel points whose gray value is 255 within a region where 1≦horizontal coordinate x≦Cᵢₓ and 1≦vertical coordinate y≦m in the binary image Gᵢ, that is, the area SLᵢ of the left-half portion of the object of the characteristic view Fᵢ;

(A2.3.2) counting the number of pixel points whose gray value is 255 within a region where Cᵢₓ+1≦horizontal coordinate x≦n and 1≦vertical coordinate y≦m in the binary image Gᵢ, that is, the area SRᵢ of the right-half portion of the object of the characteristic view Fᵢ; and

(A2.3.3) calculating the object horizontal symmetry

$${T}_{i , 3} = \frac{{SL}_{i}}{{SR}_{i}}$$

of the characteristic view Fᵢ.

Furthermore, a manner of extracting the feature, the object main-axis inclination angle T_{i,4} includes:

(A2.4.1) calculating a horizontal coordinate xᵢ₀ and a vertical coordinate yᵢ₀ of a gravity center of the binary image Gᵢ corresponding to the characteristic view Fᵢ:

$$\{ \begin{matrix}{x}_{i 0} = {M}_{i} ( 1 , 0 ) / {M}_{i} ( 0 , 0 ) \\ {y}_{i 0} = {M}_{i} ( 0 , 1 ) / {M}_{i} ( 0 , 0 )\end{matrix} ,$$

where in the formula,

$${M}_{i} ( k , j ) = {\sum }_{x = 1}^{n} {\sum }_{y = 1}^{m} {x}^{k} {y}^{j} {f}_{i} ( x , y ) ,$$

k=0, 1, and j=0, 1;

(A2.4.2) calculating a p+q^{th} central moment μᵢ(p,q) corresponding to the binary image Gᵢ corresponding to the characteristic view Fᵢ:

$${μ}_{i} ( p , q ) = {\sum }_{x = 1}^{n} {\sum }_{y = 1}^{m} {( x - {x}_{i 0} )}^{p} {( y - {y}_{i 0} )}^{q} {g}_{i} ( x , y ) ,$$

where p=0, 1, 2, and q=0, 1, 2;

(A2.4.3) constructing a real symmetrical matrix

$$Mat = [ \begin{matrix}{μ}_{i} ( 2 , 0 ) , {μ}_{i} ( 1 , 1 ) \\ {μ}_{i} ( 1 , 1 ) , {μ}_{i} ( 0 , 2 )\end{matrix} ] ,$$

and calculating feature values V₁ and V₂ of the matrix Mat and feature vectors

$${S}_{1} = [ \begin{matrix}{S}_{1 y} \\ {S}_{1 x}\end{matrix} ]$$

and

$${S}_{2} = [ \begin{matrix}{S}_{2 y} \\ {S}_{2 x}\end{matrix} ]$$

corresponding to the feature vectors; and

(A2.4.4) calculating the object main-axis inclination angle Tᵢ₄ of the characteristic view Fᵢ:

$${T}_{i , 4} = \{ \begin{matrix}atan 2 ( \vert {S}_{1 x} \vert , {S}_{1 y} ) * 180 / π , & {V}_{1} \geq {V}_{2} , {S}_{1 x} \leq 0 \\ 180 - atan 2 ( \vert {S}_{1 x} \vert , {S}_{1 y} ) * 180 / π , & {V}_{1} \geq {V}_{2} , {S}_{1 x} > 0\end{matrix} ; and \\ {T}_{i , 4} = \{ \begin{matrix}atan 2 ( \vert {S}_{2 x} \vert , {S}_{2 y} ) * 180 / π , & {V}_{1} < {V}_{2} , {S}_{2 x} \leq 0 \\ 180 - atan 2 ( \vert {S}_{2 x} \vert , {S}_{2 y} ) * 180 / π , & {V}_{1} < {V}_{2} , {S}_{2 x} > 0\end{matrix} ,$$

where

in the formula, the symbol π represents a ratio of the circumference of a circle to the diameter thereof, and the symbol a tan2 represents an arctangent function.

Furthermore, normalization processing is further performed on the geometrical feature library constructed in Step (A2), and normalization processing is performed on the features extracted from the image to be tested in Step (B2).

Furthermore, a specific implementation manner of the acquiring, according to a space object three-dimensional model, multi-viewpoint characteristic views of the object for characterizing various attitudes of the object in Step (A1) includes:

dividing a Gaussian observation sphere into K two-dimensional planes at an angle interval of γ for pitching angle α and at an interval of γ for yaw angle β, where α=−180° to 0°, β=−180° to 180°, and K=360*180/γ²; and

placing the space object three-dimensional model O_{T} at the spherical center of the Gaussian observation sphere, and performing orthographic projection of the three-dimensional model O_{T} from the spherical center respectively onto the K two-dimensional planes, to obtain multi-viewpoint characteristic views Fᵢ of K three-dimensional template objects in total, where each characteristic view Fᵢ is a pixel matrix whose width is n and height is m, fᵢ(x, y) is a pixel gray value at a point (x,y) in Fᵢ, 1≦horizontal coordinate x≦n, 1≦vertical coordinate y≦m, and i=1, 2, . . . , and K.

Furthermore, in Step (B1), noise suppression is first performed on the image to be tested by using non-local means filtering first, and then deblurring is performed by using a maximum likelihood estimation algorithm.

Furthermore, a specific implementation manner of (B3) includes:

(B3.1) traversing the entire geometrical feature library SMF, and calculating Euclidean distances, represented as D₁, . . . , and D_{K}, between four geometrical features {SG₁,SG₂,SG₃,SG₄} of the image to be tested and each row of vectors in the geometrical feature library SMF, where K is a quantity of the multi-viewpoint characteristic views of the object; and

(B3.2) choosing four minimum values D_{S}, Dₜ, Dᵤ, and Dᵥ from the Euclidean distances D₁, . . . , and D_{K}, and calculating an arithmetic mean of four object attitudes corresponding to the four minimum values, where the arithmetic mean is an object attitude in the image to be tested.

An attitude estimation system for an on-orbit three-dimensional space object includes an offline feature library construction module and an online attitude estimation module, where

the offline feature library construction module specifically includes:

a first sub-module, configured to acquire, according to a space object three-dimensional model, multi-viewpoint characteristic views of the object for characterizing various attitudes of the space object; and

a second sub-module, configured to extract geometrical features from each space object multi-viewpoint characteristic view to form a geometrical feature library, where the geometrical features include an object main body height-width ratio T_{i,1}, an object longitudinal symmetry T_{i,2}, an object horizontal symmetry T_{i,3}, and an object main-axis inclination angle T_{i,4}, where the object main body height-width ratio T_{i,1} refers to a height-width ratio of an minimum bounding rectangle of the object; the object longitudinal symmetry T_{i,2} refers to a ratio of an area of the upper-half portion of the object to an area of the lower-half portion of the object within a rectangular region enclosed by the minimum bounding rectangle of the object; the object horizontal symmetry T_{i,3} refers to a ratio of an area of the left-half portion of the object to an area of the right-half portion of the object within the rectangular region enclosed by the minimum bounding rectangle of the object; and the object main-axis inclination angle T_{i,4} refers to an included angle between an object cylinder-body main axis and a view horizontal direction of a characteristic view; and

the online attitude estimation module specifically includes:

a third sub-module, configured to preprocess an on-orbit space object image to be tested;

a fourth sub-module, configured to extract features from the image to be tested after preprocessing, where the features are the same as the features extracted by the second sub-module; and

a fifth sub-module, configured to match the features extracted from the image to be tested in the geometrical feature library, where a space object attitude characterized by a characteristic view corresponding to a matching result is an object attitude in the image to be tested.

Technical effects of the present invention lie in that:

In the present invention, Step (A1) and Step (A2) are an offline training stage, in which multi-viewpoint characteristic views of the object are acquired by using a three-dimensional template object model, geometrical features of characteristic views are extracted, and further a geometrical feature library of the template object is established. Step (B1) and Step (B2) are an online estimation stage of an attitude of the image to be tested, and a geometrical feature of the image to be tested is compared with the geometrical feature library of the template object, so as to obtain the attitude of the image to be tested through estimation. A geometrical feature specifically used for matching in the present invention has scale invariance; therefore, as long as a relative dimension scale and position relationship between various components of an object are accurately acquired in a three-dimensional modeling stage, subsequent relatively high matching precision can be ensured. The entire method is simple to implement and has desirable robustness, high attitude estimation precision, low susceptibility to an imaging condition, and desirable applicability.

As an optimization, normalization processing is performed on extracted geometrical features, so that influence of each characteristic quantity on attitude estimation can be effectively balanced; an operation of preprocessing the image to be tested is performed, and non-local means filtering and a maximum likelihood estimation algorithm are preferably chosen to perform denoising and deblurring processing on the image to be tested, thereby improving attitude estimation precision of the algorithm under a turbulence blurring imaging condition; and a weighted arithmetic mean of an attitude estimation result is calculated, thereby improving the stability of the attitude estimation algorithm.

### BRIEF DESCRIPTION OF THE DRAWINGS

FIG. 1 is a schematic view of attitude estimation;

FIG. 2 is a schematic flowchart of the present invention;

FIG. 3 is a schematic view of a Gaussian observation sphere;

FIG. 4 is a schematic view of a three-dimensional model of a Hubble telescope;

FIG. 5(a) is a characteristic view of a projection of the Hubble telescope in a case that a pitching angle α=0° and a yaw angle β=0°;

FIG. 5(b) is a characteristic view of a projection of the Hubble telescope in a case that a pitching angle α=0° and a yaw angle β=0°;

FIG. 5(c) is a characteristic view of a projection of the Hubble telescope in a case that a pitching angle α=−90° and a yaw angle β=90°;

FIG. 5(d) is a characteristic view of a projection of the Hubble telescope in a case that a pitching angle a=−180° and a yaw angle β=90°;

FIG. 6(a) is a characteristic view F, of a particular frame of the Hubble telescope;

FIG. 6(b) is a result of segmentation performed on FIG. 6(a) by using a threshold criterion of a maximum between-cluster variance;

FIG. 6(c) is a schematic view of an object height-width ratio of the Hubble telescope, where a rectangular box ABCD is a minimum bounding rectangle of the characteristic view Fᵢ, |AC| is an object main body height Hᵢ of the characteristic view Fᵢ, and |CD| is an object main body width Wᵢ of the characteristic view Fᵢ,

FIG. 6(d) is a schematic view of an object longitudinal symmetry of the Hubble telescope, where a region enclosed by a rectangular box abcd is an upper-half portion of the object of the characteristic view Fᵢ, and a region enclosed by a rectangle cdef is a lower-half portion of the object of the characteristic view Fᵢ;

FIG. 6(e) is a schematic view of an object horizontal symmetry of the Hubble telescope, where a region enclosed by a rectangular box hukv is a left-half portion of the object of the characteristic view Fᵢ, and a region enclosed by a rectangle ujvl is a right-half portion of the object of the characteristic view Fᵢ;

FIG. 6(f) is a schematic view of an object main-axis inclination angle of the Hubble telescope, where the vector \vec{PQ} is an object cylinder-body main axis of the characteristic view F, and an included angle ∠QOR between the vector \vec{PQ} and a horizontal direction is the object main-axis inclination angle, i.e., a main-axis inclination angle of a satellite platform of the Hubble telescope;

FIG. 7(a) is an image of a simulated Hubble telescope, where a corresponding pitching angle α and a corresponding yaw angle β are (α,β)=(−40°,−125°);

FIG. 7(b) is a result of non-local means filtering performed on FIG. 7(a);

FIG. 7(c) is a result of an algorithm calibration of a maximum likelihood estimation algorithm (MAP) performed on 7(b);

FIG. 7(d) is an attitude estimation result 1 of FIG. 7(c): (α,β)=(−40°, −130°);

FIG. 7(e) is an attitude estimation result 2 of FIG. 7(c): (α,β)=(−40°, −140°);

FIG. 7(f) is an attitude estimation result 3 of FIG. 7(c): (α,β)=(−40°, −120°);

FIG. 7(g) is an attitude estimation result 4 of FIG. 7(c): (α,β)=(−40°, −150°); and

FIG. 7(h) is a result of an arithmetic mean of FIG. 7(d) to FIG. 7(g), and the result is used as an eventual attitude estimation result (α,β)=(−40°, −135°) of FIG. 7(c).

### DETAILED DESCRIPTION

To make the objectives, technical solutions, and advantages of the present invention clearer and more comprehensible, the present invention is further described below in detail with reference to the accompanying drawings and the embodiments. It should be understood that the specific embodiments described here are merely used to explain the present invention rather than to limit the present invention. In addition, the technical features involved in the implementation manners of the present invention described below can be combined with each other as long as the technical features do not conflict with each other.

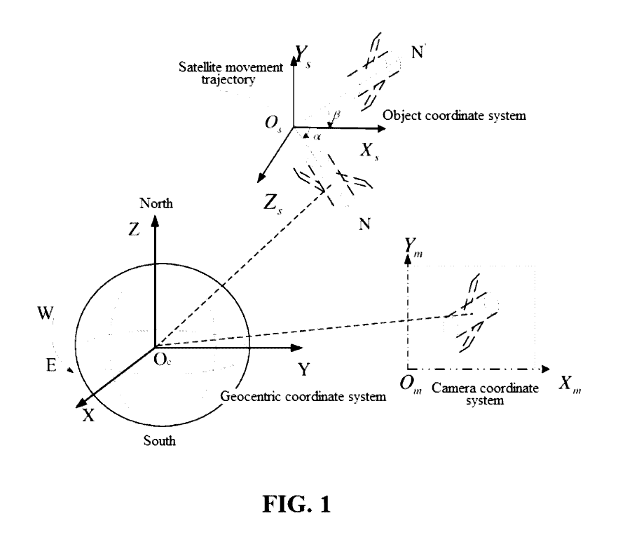

In the present invention, an on-orbit three-dimensional space object is an on-orbit Hubble telescope, and the structure of a satellite platform of the Hubble telescope is a cylinder. Two rectangular solar panels are mainly carried on the satellite platform, and an object attitude that needs to be estimated refers to an attitude of the satellite platform in the three-dimensional object coordinate system. FIG. 1 is a schematic view of attitude estimation. In the geocentric coordinate system, the X axis points to the prime meridian, the Z axis points to due north, and the direction of the Y axis is determined according to the right-hand rule. In the object coordinate system, the center of mass of the object satellite always points to the center of the earth, the Xₛ axis is parallel to the Y axis in the geocentric coordinate system, and the Yₛ axis is parallel to the Z axis in the geocentric coordinate system. The attitude estimation is to estimate, from an object satellite projection image in a camera coordinate system, a pitching angle α, i.e., ∠N′O_{S}N and a yaw angle ⊕, i.e., ∠N′O_{S}X_{S} of a three-dimensional object satellite in the object coordinate system. OₛN is an axis of the cylindrical satellite platform. O_{S}N′ is a projection of the axis O_{S}N of the satellite platform on a plane X_{S}O_{S}Y_{S}. A camera plane XₘOₘYₘ is parallel to the plane X_{S}O_{S}Y_{S} in the object coordinate system, and is also parallel to a YOZ plane in the geocentric coordinate system.

The present invention is further described below in detail by using the structure of an object shown in FIG. 4 as an example. The present invention is further described below with reference to the accompanying drawings and the embodiments.

A procedure of the present invention is shown in FIG. 2. A specific implementation method includes the following steps, including: a step of acquiring multi-viewpoint characteristic views of a template object, a step of establishing a geometrical feature library of the template object, a step of calculating geometrical features of an image to be tested, and an object attitude estimation step.

(A1) Step of acquiring multi-viewpoint characteristic views of a template object includes the following sub-steps:

(A1.1) Step of establishing a template object three-dimensional model:

For a cooperative space object, for example, a satellite object, detailed three-dimensional structures and relative position relationships such as a satellite platform, a load carried by a satellite, and relative position relationships among components of the satellite can be precisely obtained. For an uncooperative space object, approximate geometrical structures and relative position relationships of various components of the object are deduced from multi-viewpoint projection images of the object. By using a priori knowledge that when an object satellite moves on an orbit, a connecting line between the center of mass of a satellite platform and the center of the earth is perpendicular to the satellite platform, that a solar panel of the object satellite always points to an incident direction of sunlight, and the like, spatial position relationships among various components of the satellite are further determined. A three-dimensional modeling tool Multigen Creator is used to establish a three-dimensional model of an object satellite. FIG. 4 is a schematic view of a three-dimensional model, established by using Multigen Creator, of the Hubble telescope;

(A1.2) Step of acquiring multi-viewpoint characteristic views of the template object:

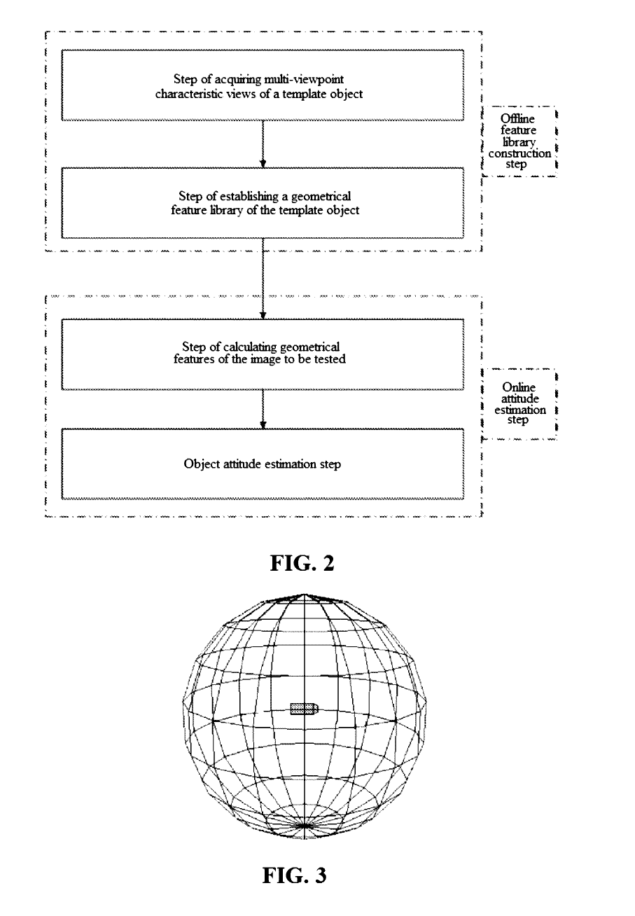

As shown in FIG. 3, a Gaussian observation sphere is divided into 2592 two-dimensional planes at an interval of γ for pitching angle α and at an interval of γ for yaw angle β, where α=−180° to 0°, β=−180° to 180°, and 3°<γ<10°. In this example, γ=5°;

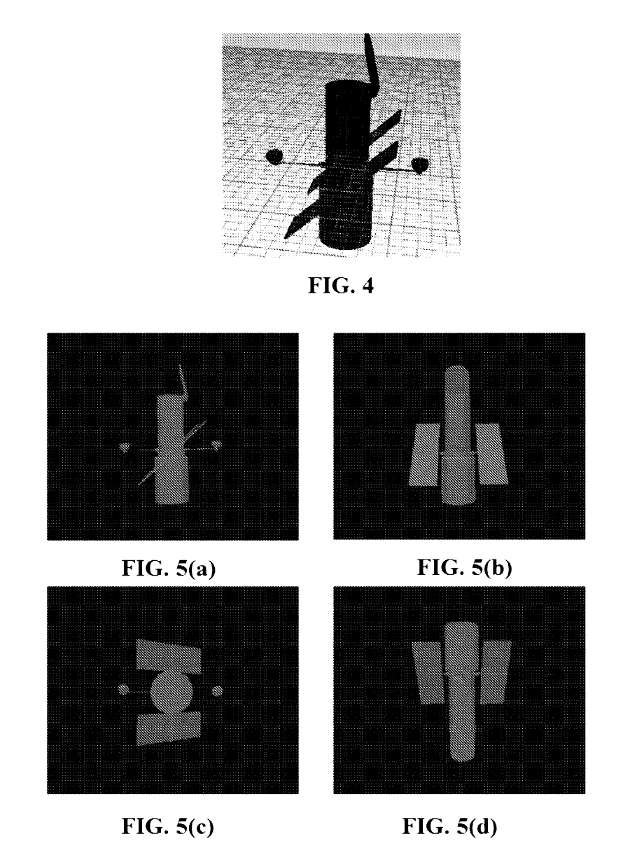

In the present invention, a Hubble telescope simulated satellite is used as the template object. As shown in FIG. 4, a three-dimensional template object Hubble telescope O_{T} is placed at the spherical center of the Gaussian observation sphere, and orthographic projection of the three-dimensional template object O_{T} from the spherical center, onto 2592 two-dimensional planes is respectively performed, to obtain multi-viewpoint characteristic views Fᵢ of in total 2592 three-dimensional template objects. FIG. 5(a) is a characteristic view corresponding to the simulated Hubble telescope with pitching angle and yaw angle) (α,β)=(0°,0°). FIG. 5(b) is a characteristic view corresponding to (α,β)=(0°,90°). FIG. 5(c) is a characteristic view corresponding to (α,β)=(−90°,90°). FIG. 5(d) is characteristic view corresponding to (α,β)=(−180°,90°). Each characteristic view Fᵢ is a pixel matrix having a width n=500 and a height m=411. fᵢ(x, y) is a pixel gray value at a point (x,y) in Fᵢ, where 1≦horizontal coordinate x≦500, 1≦vertical coordinate y≦411, i=1, 2, . . . , and K, and K=2592.

(A2) Step of establishing a geometrical feature library of the template object includes the following sub-steps:

This example is described by using i=1886 frames of 2592 frame characteristic views as an example:

(A2.1) Calculate an object main body height-width ratio T_{i,1} of each characteristic view Fᵢ:

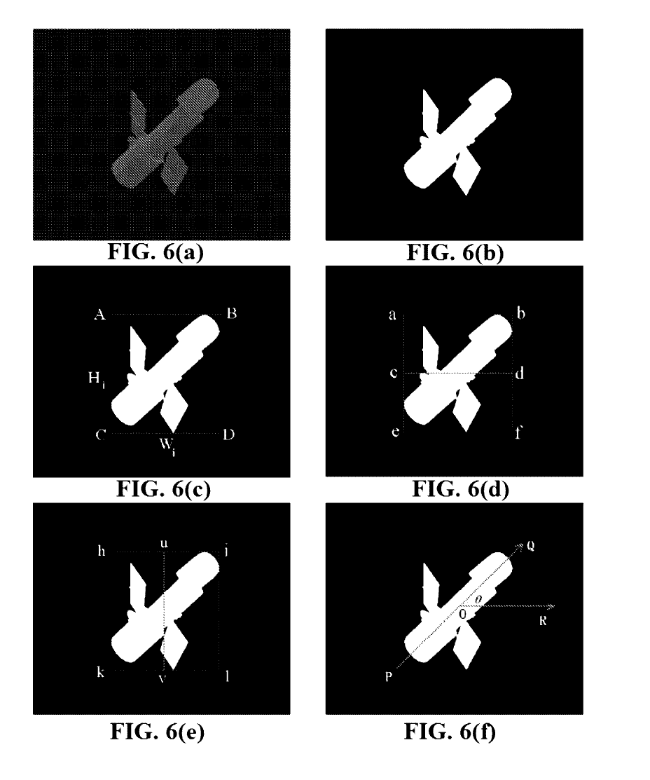

(A2.1.1) Obtain a threshold Tᵢ=95 by using a threshold criterion of a maximum between-cluster variance for the input characteristic view Fᵢ shown in FIG. 6(a), whose corresponding pitching angle and yaw angle are (α,β)=(−50°,−115°). Set a pixel gray value fᵢ(x, y) greater than 95 in a pixel matrix Fᵢ as 255, and set a pixel gray value fᵢ(x, y) less than or equal to 95 as zero, to obtain a binary image Gᵢ shown in FIG. 6(b), where gᵢ(x, y) is a pixel gray value at a point (x,y) in a pixel matrix Gᵢ.

(A2.1.2) Scan the binary image Gᵢ in an order from top to bottom and from left to right, if a current point pixel value gᵢ(x, y) is equal to 255, record a current pixel horizontal coordinate x=Topj, and a vertical coordinate y=Topi, and stop scanning, where in this example, Topj=272, and Topi=87.

(A2.1.3) Scan the binary image Gᵢ in an order from bottom to top and from left to right, if a current point pixel value gᵢ(x, y) is equal to 255, record a current pixel horizontal coordinate x=Bntj, and a vertical coordinate y=Bnti, and stop scanning, where in this example, Bntj=330, and Bnti=315.

(A2.1.4) Scan the binary image Gᵢ in an order from left to right and from top to bottom, if a current point pixel value gᵢ(x, y) is equal to 255, record a current pixel horizontal coordinate x=Leftj, and a vertical coordinate y=Lefti, and stop scanning, where in this example, Leftj=152, and Lefti=139.

(A2.1.5) Scan the binary image Gᵢ in an order from right to left and from top to bottom, if a current point pixel value gᵢ(x, y) is equal to 255, record a current pixel horizontal coordinate x=Rightj, and a vertical coordinate y=Righti, and stop scanning, where in this example, Rightj=361, and Righti=282.

(A2.1.6) Define the object main body height-width ratio of the characteristic view Fᵢ as a ratio

$${T}_{i , 1} = \frac{{H}_{i}}{{W}_{i}}$$

of an object height Hᵢ to an object width Wᵢ, where Hᵢ=|TopiBnti|, Wᵢ=|Leftj−Rightj|, and the symbol |V| represents an absolute value of the variable V. As shown in FIG. 6(c), the object main body height-width ratio T_{i,1} is a ratio of an object main body height AC to an object main body width CD. In this example, T_{i,1}=1.0909, Hᵢ=228, and Wᵢ=209.

(A2.2) Calculate an object longitudinal symmetry T_{i,2} of each characteristic view Fᵢ:

(A2.2.1) Calculate a horizontal coordinate Cᵢₓ=└(Leftj+Rightj)/2┘ and a vertical coordinate C_{iy}=└(Topi+Bnti)/2┘ of a central point of the characteristic view Fᵢ, where the symbol └V┘ represents taking an integral part for the variable V, where in this example, Cᵢₓ=256, and C_{iy}=201.

(A2.2.2) Count the number of pixel points whose gray value gᵢ(x, y) is 255 within a region where 1≦horizontal coordinate x≦500 and 1≦vertical coordinate y≦201 in the binary image Gᵢ, that is, the area STᵢ of the upper-half portion of the object of the characteristic view Fᵢ. In this example, an area of a region enclosed by a rectangular box abcd in FIG. 6(d) is STᵢ=10531.

(A2.2.3) Count the number of pixel points whose gray value gᵢ(x, y) is 255 within a region where 1≦horizontal coordinate x≦500 and 202<≦vertical coordinate y≦411 in the binary image Gᵢ, that is, the area SDᵢ of the lower-half portion of the object of the characteristic view Fᵢ. In this example, an area of a region enclosed by a rectangular box cdef in FIG. 6(d) is SDᵢ=9685.

(A2.2.4) Calculate the object longitudinal symmetry

$${T}_{i , 2} = \frac{{ST}_{i}}{{SD}_{i}}$$

of the characteristic view Fᵢ.

The object longitudinal symmetry of the characteristic view Fᵢ is defined as a ratio of an area STᵢ of the upper-half portion of the object to an area SDᵢ of the lower-half portion within a rectangular region enclosed by an minimum bounding rectangle of the object, where in this example, T_{i,2}=1.0873.

(A2.3) Calculate an object horizontal symmetry T_{i,3} of each characteristic view Fᵢ:

(A2.3.1) Count the number of pixel points whose gray value gᵢ(x, y) is 255 within a region where 1≦horizontal coordinate x≦Cᵢₓ and 1≦vertical coordinate y≦m in the binary image Gᵢ, that is, the area SLᵢ of the left-half portion of the object of the characteristic view Fᵢ. In this example, an area of a region enclosed by a rectangular box hukv in FIG. 6(e) is SLᵢ=10062.

(A2.3.2) Count the number of pixel points whose gray value gᵢ(x, y) is 255 within a region where Cᵢₓ+1≦horizontal coordinate x≦n and 1≦vertical coordinate y≦m in the binary image Gᵢ, that is, the area SRᵢ of the right-half portion of the object of the characteristic view Fᵢ. In this example, an area of a region enclosed by a rectangular box ujvl in FIG. 6(e) is SRᵢ=10154.

(A2.3.3) Calculate the object horizontal symmetry

$${T}_{i , 3} = \frac{{SL}_{i}}{{SR}_{i}}$$

of the characteristic view Fᵢ.

The object horizontal symmetry of the characteristic view Fᵢ is defined as a ratio of an area SLᵢ of the left-half portion of the object to an area SRᵢ of the right-half portion within a rectangular region enclosed by a minimum bounding rectangle of the object, where in this example, T_{i,3}=0.9909.

(A2.4) Calculate an object main-axis inclination angle T_{i,4} of the characteristic view Fᵢ:

The object main-axis inclination angle is defined as an included angle θ between an object cylinder-body axis of the characteristic view Fᵢ and an image horizontal direction. The feature represents an attitude feature of an object most distinctively, has a value range of 0° to 180°, and is represented by using a one-dimensional floating-point number.

FIG. 6(f) is a schematic view of the object main-axis inclination angle of the Hubble telescope. The vector \vec{PQ} is the object cylinder-body main axis (a satellite platform main axis of the Hubble telescope in this example) of the characteristic view Fᵢ, and an included angle ∠QOR between the vector \vec{PQ} and the horizontal direction \vec{OR} is the object main-axis inclination angle.

(A2.4.1) Calculate a horizontal coordinate Xᵢ₀ and a vertical coordinate yᵢ₀ of a gravity center of the binary image Gᵢ corresponding to each characteristic view Fᵢ, where in this example, xᵢ₀=252, and yᵢ₀=212.

(A2.4.2) Calculate a p+q^{th} central moment μᵢ(p, q) of the binary image Gᵢ corresponding to the characteristic view Fᵢ.

(A2.4.3) Construct a real symmetrical matrix

$$Mat = [ \begin{matrix}{μ}_{i} ( 2 , 0 ) , {μ}_{i} ( 1 , 1 ) \\ {μ}_{i} ( 1 , 1 ) , {μ}_{i} ( 0 , 2 )\end{matrix} ] ,$$

and calculate feature values V₁ and V₂ of the matrix Mat and feature vectors

$${S}_{1} = [ \begin{matrix}{S}_{1 y} \\ {S}_{1 x}\end{matrix} ] and {S}_{2} = [ \begin{matrix}{S}_{2 y} \\ {S}_{2 x}\end{matrix} ]$$

corresponding to the feature vectors, where in this example,

$$Mat = [ \begin{matrix}1.3385 \times {10}^{10} , & - 8.4494 \times {10}^{9} \\ - 8.4494 \times {10}^{9} , & 1.6366 \times {10}^{10}\end{matrix} ] ,$$

the feature values are V₁=6.2955×10⁹ and V₂=2.3455×10¹⁰, and the feature vectors are

$${S}_{1} = [ \begin{matrix}- 0.7661` \\ - 0.6427\end{matrix} ] and {S}_{2} [ \begin{matrix}- 0.6427 \\ 0.7761\end{matrix} ] .$$

(A2.4.4) Calculate the object main-axis inclination angle Tᵢ₄ shown in FIG. 6(a) of the characteristic view Fᵢ by using the following formulas:

$${T}_{i , 4} = \{ \begin{matrix}atan 2 ( \vert {S}_{1 x} \vert , {S}_{1 y} ) * 180 / π , & {V}_{1} \geq {V}_{2} , {S}_{1 x} \leq 0 \\ 180 - atan 2 ( \vert {S}_{1 x} \vert , {S}_{1 y} ) * 180 / π , & {V}_{1} \geq {V}_{2} , {S}_{1 x} > 0\end{matrix} ; and \\ {T}_{i , 4} = \{ \begin{matrix}atan 2 ( \vert {S}_{2 x} \vert , {S}_{2 y} ) * 180 / π , & {V}_{1} < {V}_{2} , {S}_{2 x} \leq 0 \\ 180 - atan 2 ( \vert {S}_{2 x} \vert , {S}_{2 y} ) * 180 / π , & {V}_{1} < {V}_{2} , {S}_{2 x} > 0\end{matrix} ,$$

where

in the formula, the symbol π represents a ratio of the circumference of a circle to the diameter thereof, and the symbol a tan 2 represents an arctangent function.

In this example, the object main-axis inclination angle Tᵢ₄=50.005°.

(A2.5) Construct a geometrical feature library MF of the multi-viewpoint characteristic views Fᵢ of the template object:

$$MF = \{ \begin{matrix}{T}_{1 , 1} , {T}_{1 , 2} , {T}_{1 , 3} , {T}_{1 , 4} \\ {T}_{2 , 1} , {T}_{2 , 2} , {T}_{2 , 3} , {T}_{2 , 4} \\ \begin{matrix}L & L & L & L & L & L & L\end{matrix} \\ {T}_{i , 1} , {T}_{i , 2} , {T}_{i , 3} , {T}_{i , 4} \\ \begin{matrix}L & L & L & L & L & L & L\end{matrix} \\ {T}_{K , 1} , {T}_{K , 2} , {T}_{K , 3} , {T}_{K , 4}\end{matrix} \} ,$$

where

in the formula, the i^{th} row {T_{i,1},T_{i,2},T_{i,3},T_{i,4}} represents a geometrical feature of the characteristic view Fᵢ of the i^{th} frame, where in this example, as shown in FIG. 6(a), {T_{i,1},T_{i,2},T_{i,3},T_{i,4}}={1.0909, 1.0873, 0.9909, 50.005}.

(A2.6) Normalization processing step:

Perform normalization processing on the geometrical feature library MF of the multi-viewpoint characteristic views Fᵢ of the template object, to obtain a normalized geometrical feature library SMF of the template object:

$$SMF = \{ \begin{matrix}{ST}_{1 , 1} , {ST}_{1 , 2} , {ST}_{1 , 3} , {ST}_{1 , 4} \\ {ST}_{2 , 1} , {ST}_{2 , 2} , {ST}_{2 , 3} , {ST}_{2 , 4} \\ \begin{matrix}L & L & L & L & L & L & L\end{matrix} \\ {ST}_{i , 1} , {ST}_{i , 2} , {ST}_{i , 3} , {ST}_{i , 4} \\ \begin{matrix}L & L & L & L & L & L & L\end{matrix} \\ {ST}_{K , 1} , {ST}_{K , 2} , {ST}_{K , 3} , {ST}_{K , 4}\end{matrix} \} ,$$

where in the formula,

$${ST}_{i , j} = \frac{{T}_{i , j}}{{Vec}_{j}} ,$$

Vecⱼ=max{T_{1,j},T_{2,j}, . . . , T_{i,j}, . . . , T_{K,j}} i=1, 2, . . . , and K, j=1, 2, 3, and 4; and the symbol Max{V} represents taking a maximum value in a set V.

An online attitude estimation step specifically includes:

(B1) Step of calculating geometrical features of the image to be tested, including the following sub-steps:

(B1.1) Step of preprocessing the image to be tested

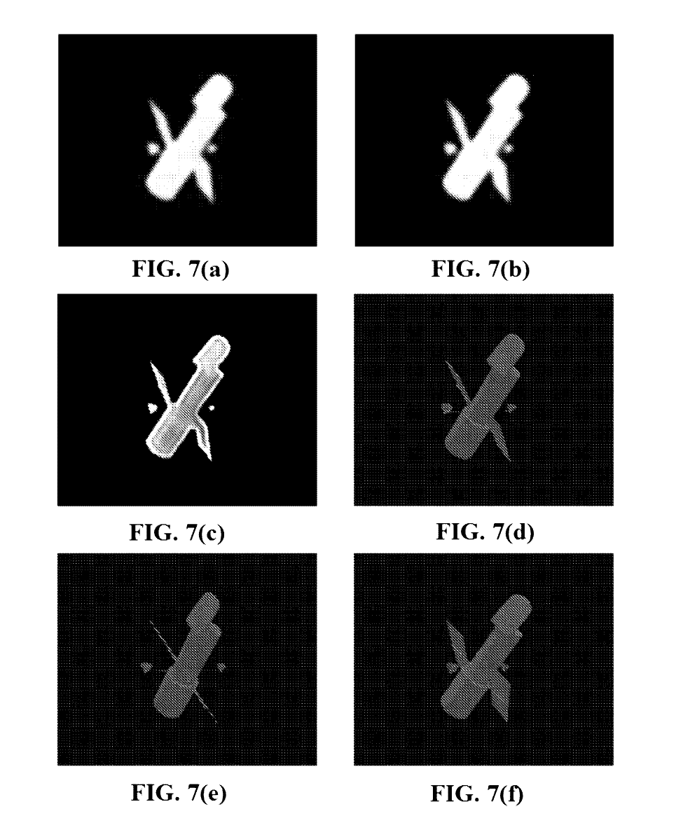

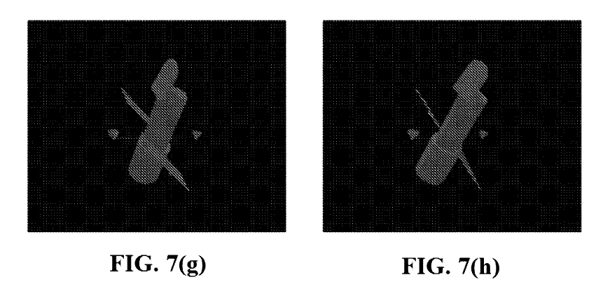

Imaging data of a space object has much noise and a low signal-to-noise ratio, and blurring is obvious. Therefore, before subsequent processing is performed on the imaging data, it is necessary to perform preprocessing on the imaging data first. That is, denoising is performed on the imaging data first, and then, for characteristics of the imaging data, an effective calibration algorithm is used to perform image restoration processing on an image of the space object. In this example, non-local means filtering (the following parameters are chosen: the size of a similarity window is 5×5, the size of a search window is 15×15, and an attenuation parameter is 15) is chosen to first perform noise suppression on the image to be tested. FIG. 7(a) shows data of ground-based long-distance optical imaging of a simulated Hubble telescope, whose corresponding pitching angle α and yaw angle β are (α,β)=(−40°,−125°). FIG. 7(b) shows a result of noise suppression performed on FIG. 7(a) by using non-local means filtering; and a maximum likelihood estimation algorithm is then chosen to perform deblurring (in this example, the following parameters are chosen: the number of outer loops is 8, and the number of inner loops of an estimated point spread function and the number of inner loops of an object image are both set as 3), to obtain the image g(x, y) after preprocessing. FIG. 7(c) shows a result of deblurring performed on FIG. 7(b) by using a maximum likelihood estimation algorithm, where the result is the image g(x, y) after preprocessing.

(B2) Step of extracting geometrical features from the image to be tested

Replace fᵢ(x, y) with the image g(x, y) after preprocessing, perform sub-step (2.1) to sub-step (2.4), to obtain geometrical features {G₁,G₂,G₃,G₄} of the image to be tested, and perform normalization processing on the geometrical features {G₁,G₂,G₃,G₄}, to obtain normalized geometrical features {SG₁,SG₂,SG₃,SG₄} of the image to be tested, where

SGⱼ=Gⱼ/Vecⱼ, and j=1,2,3,4.

(B3) Object attitude estimation step, including the following sub-steps:

(B3.1) Traverse the entire geometrical feature library SMF of the template object, and calculate Euclidean distances D₁, . . . , and D_{K} between geometrical features {SG₁,SG₂,SG₃,SG₄} of the image to be tested and each row of vectors in SMF; and

(B3.2) Choose four minimum values D_{S}, Dₜ, Dᵤ, and Dᵥ from the Euclidean distances D₁, . . . , and D_{K}, where an attitude of the image to be tested is set as an arithmetic mean of pattern attitudes represented by D_{S}, Dₜ, Dᵤ, and Dᵥ. FIG. 7(d) to FIG. 7(g) show pattern attitudes represented by D_{S}, Dₜ, Dᵤ, and Dᵥ, whose corresponding pitching angle α and yaw angle β are respectively (α,β)=(−40°,−130°), (α,β)=(−40°,−140°), (α,β)=(−40°,−120°), and (α,β)=(−40°,−150°). FIG. 7(h) is an attitude estimation result obtained by performing an operation of calculating an arithmetic mean on FIG. 7(d) to FIG. 7(g), where) (α,β)=(−40°,−135°), that is, a result of attitude estimation performed on FIG. 7(a).

The results show that a precision error of an estimation result of the pitching angle is zero degree, and a precision error of an estimation result of the yaw angle β is within 10 degrees.

A person skilled in the art easily understands that the foregoing merely provides preferred embodiments of the present invention, which are not used to limit the present invention. Any modifications, equivalent replacements, and improvements made within the spirit and principle of the present invention shall all fall within the protection scope of the present invention.

1. An attitude estimation method for an on-orbit three-dimensional space object, comprising an offline feature library construction step and an online attitude estimation step, wherein
the offline feature library construction step specifically comprises:
(A1) acquiring, according to a space object three-dimensional model, multi-viewpoint characteristic views of the object for characterizing various attitudes of the space object; and
(A2) extracting geometrical features from each space object multi-viewpoint characteristic view to form a geometrical feature library, wherein the geometrical features comprise an object main body height-width ratio T_{i,1}, an object longitudinal symmetry T_{i,2}, an object horizontal symmetry, T_{i,3}, and an object main-axis inclination angle T_{i,4}, wherein the object main body height-width ratio T_{i,1} refers to a height-width ratio of an minimum bounding rectangle of the object; the object longitudinal symmetry T_{i,2} refers to a ratio of an area of the upper-half portion of the object to an area of the lower-half portion of the object within a rectangular region enclosed by the minimum bounding rectangle of the object; the object horizontal symmetry T_{i,3} refers to a ratio of an area of the left-half portion of the object to an area of the right-half portion of the object within the rectangular region enclosed by the minimum bounding rectangle of the object; and the object main-axis inclination angle T_{i,4} refers to an included angle between an object cylinder-body main axis and a view horizontal direction of a characteristic view; and
the online attitude estimation step specifically comprises:
(B1) preprocessing an on-orbit space object image to be tested;
(B2) extracting features from the image to be tested after preprocessing, wherein the features are the same as the features extracted in Step (A2); and
(B3) matching the features extracted from the image to be tested in the geometrical feature library, wherein a space object attitude characterized by a characteristic view corresponding to a matching result is an object attitude in the image to be tested.

2. The attitude estimation method for an on-orbit three-dimensional space object according to claim 1, wherein a manner of extracting the feature, the object main body height-width ratio T_{i,1} comprises:
(A2.1.1) obtaining a threshold T, by using a threshold criterion of a maximum between-cluster variance for a characteristic view Fᵢ, setting a pixel gray value fᵢ(x, y) greater than the threshold Tᵢ in the characteristic view Fᵢ as 255, and setting a pixel gray value fᵢ(x, y) less than or equal to the threshold Tᵢ as zero, thereby obtaining a binary image Gᵢ, wherein Gᵢ is a pixel matrix whose width is n and height is m, and gᵢ(x, y) is a pixel gray value at a point (x,y) in Gᵢ;
(A2.1.2) scanning the binary image Gᵢ in an order from top to bottom and from left to right, if a current point pixel value gᵢ(x, y) is equal to 255, recording a current pixel horizontal coordinate x=Topj, and a vertical coordinate y=Topi, and stopping scanning;
(A2.1.3) scanning the binary image Gᵢ in an order from bottom to top and from left to right, if a current point pixel value gᵢ(x, y) is equal to 255, recording a current pixel horizontal coordinate x=Bntj, and a vertical coordinate y=Bnti, and stopping scanning;
(A2.1.4) scanning the binary image Gᵢ in an order from left to right and from top to bottom, if a current point pixel value gᵢ(x, y) is equal to 255, recording a current pixel horizontal coordinate x=Leftj, and a vertical coordinate y=Lefti, and stopping scanning;
(A2.1.5) scanning the binary image Gᵢ in an order from right to left and from top to bottom, if a current point pixel value gᵢ(x, y) is equal to 255, recording a current pixel horizontal coordinate x=Rightj, and a vertical coordinate y=Righti, and stopping scanning; and
(A2.1.6) defining the object main body height-width ratio of the characteristic view Fᵢ as
$${T}_{i , 1} = \frac{{H}_{i}}{{W}_{i}} ,$$
wherein Hᵢ=|Topi−Bnti|, Wᵢ=|Leftj−Rightj|, and the symbol |V| represents an absolute value of the variable V.

3. The attitude estimation method for an on-orbit three-dimensional space object according to claim 2, wherein a manner of extracting the feature, the object longitudinal symmetry T_{i,2} comprises:
(A2.2.1) calculating a horizontal coordinate Cᵢₓ=└(Leftj+Rightj)/2┘ and a vertical coordinate Cᵢ=└(Topi+Bnti)/2┘ of a central point of the characteristic view Fᵢ, wherein the symbol └V┘ represents taking an integral part for the variable V;
(A2.2.2) counting the number of pixel points whose gray value is 255 within a region where 1≦horizontal coordinate x≦n and 1≦vertical coordinate y≦C_{iy} in the binary image Gᵢ, that is, the area STᵢ of the upper-half portion of the object of the characteristic view Fᵢ;
(A2.2.3) counting the number of pixel points whose gray value is 255 within a region where 1≦horizontal coordinate x≦n and C_{iy}+1≦vertical coordinate y≦m in the binary image Gᵢ, that is, the area SDᵢ of the lower-half portion of the object of the characteristic view Fᵢ; and
(A2.2.4) calculating the object longitudinal symmetry
$${T}_{i , 2} = \frac{{ST}_{i}}{{SD}_{i}}$$
of the characteristic view Fᵢ.

4. The attitude estimation method for an on-orbit three-dimensional space object according to claim 3, wherein a manner of extracting the feature, the object horizontal symmetry T_{i,3} comprises:
(A2.3.1) counting the number of pixel points whose gray value is 255 within a region where 1≦horizontal coordinate x≦Cᵢₓ and 1≦vertical coordinate y≦m in the binary image Gᵢ, that is, the area SLᵢ of the left-half portion of the object of the characteristic view Fᵢ;
(A2.3.2) counting the number of pixel points whose gray value is 255 within a region where Cᵢₓ+1≦horizontal coordinate x≦n and 1≦vertical coordinate y≦m in the binary image Gᵢ, that is, the area SRᵢ of the right-half portion of the object of the characteristic view Fᵢ; and
(A2.3.3) calculating the object horizontal symmetry
$${T}_{i , 3} = \frac{{SL}_{i}}{{SR}_{i}}$$
of the characteristic view Fᵢ.

5. The attitude estimation method for an on-orbit three-dimensional space object according to claim 4, wherein a manner of extracting the feature, the object main-axis inclination angle T_{i,4} comprises:
(A2.4.1) calculating a horizontal coordinate xᵢ₀ and a vertical coordinate yᵢ₀ of a gravity center of the binary image Gᵢ corresponding to the characteristic view Fᵢ:
$$\{ \begin{matrix}{x}_{i 0} = {M}_{i} ( 1 , 0 ) / {M}_{i} ( 0 , 0 ) \\ {y}_{i 0} = {M}_{i} ( 0 , 1 ) / {M}_{i} ( 0 , 0 )\end{matrix} ,$$
wherein in the formula,
$${M}_{i} ( k , j ) = {\sum }_{x = 1}^{n} {\sum }_{y = 1}^{m} {x}^{k} {y}^{j} {f}_{i} ( x , y ) ,$$
k=0, 1, and j=0, 1;
(A2.4.2) calculating a p+g^{th} central moment μᵢ(p,q) corresponding to the binary image Gᵢ corresponding to the characteristic view Fᵢ:
$${μ}_{i} ( p , q ) = {\sum }_{x = 1}^{n} {\sum }_{y = 1}^{m} {( x - {x}_{i 0} )}^{p} {( y - {y}_{i 0} )}^{q} {g}_{i} ( x , y ) ,$$
wherein p=0, 1, and 2, and q=0, 1, and 2;
(A2.4.3) constructing a real symmetrical matrix
$$Mat = [ \begin{matrix}{μ}_{i} ( 2 , 0 ) , & {μ}_{i} ( 1 , 1 ) \\ {μ}_{i} ( 1 , 1 ) , & {μ}_{i} ( 0 , 2 )\end{matrix} ] ,$$
and calculating feature values V₁ and V₂ of the matrix Mat and feature vectors
$${S}_{1} = [ \begin{matrix}{S}_{1 y} \\ {S}_{1 x}\end{matrix} ] and {S}_{2} = [ \begin{matrix}{S}_{2 y} \\ {S}_{2 x}\end{matrix} ]$$
corresponding to the feature vectors; and
(A2.4.4) calculating the object main-axis inclination angle Tᵢ₄ of the characteristic view Fᵢ:
$${T}_{i , 4} = \{ \begin{matrix}atan 2 ( \vert {S}_{1 x} \vert , {S}_{1 y} ) * 180 / π , & {V}_{1} \geq {V}_{2} , {S}_{1 x} \leq 0 \\ 180 - atan 2 ( \vert {S}_{1 x} \vert , {S}_{1 y} ) * 180 / π , & {V}_{1} \geq {V}_{2} , {S}_{1 x} > 0\end{matrix} ; and \\ {T}_{i , 4} = \{ \begin{matrix}atan 2 ( \vert {S}_{2 x} \vert , {S}_{2 y} ) * 180 / π , & {V}_{1} < {V}_{2} , {S}_{2 x} \leq 0 \\ 180 - atan 2 ( \vert {S}_{2 x} \vert , {S}_{2 y} ) * 180 / π , & {V}_{1} < {V}_{2} , {S}_{2 x} > 0\end{matrix} ,$$
wherein
in the formula, the symbol π represents a ratio of the circumference of a circle to the diameter thereof, and the symbol a tan 2 represents an arctangent function.

6. The attitude estimation method for an on-orbit three-dimensional space object according to claim 1, further comprising: performing normalization processing on the geometrical feature library constructed in Step (A2), and performing normalization processing on the features extracted from the image to be tested in Step (B2).

7. The attitude estimation method for an on-orbit three-dimensional space object according to claim 1, a specific implementation manner of the acquiring, according to a space object three-dimensional model, multi-viewpoint characteristic views of the object for characterizing various attitudes of the object in Step (A1) comprises:
dividing a Gaussian observation sphere into K two-dimensional planes at an angle interval of γ for pitching angle α and at an interval of γ for yaw angle β, wherein α=−180° to 0°, β=−180° to 180°, and K=360*180/β₂; and
placing the space object three-dimensional model O_{T} at the spherical center of the Gaussian observation sphere, and performing orthographic projection of the three-dimensional model O_{T} from the spherical center respectively onto the K two-dimensional planes, to obtain multi-viewpoint characteristic views Fᵢ of K three-dimensional template objects in total, wherein each characteristic view Fᵢ is a pixel matrix whose width is n and height is m, fᵢ(x,y) is a pixel gray value at a point (x,y) in Fᵢ, 1≦horizontal coordinate x≦n, 1≦vertical coordinate y≦m, and i=1, 2, . . . , and K.

8. The attitude estimation method for an on-orbit three-dimensional space object according to claim 1, wherein in Step (B1), noise suppression is first performed on the image to be tested by using non-local means filtering first, and then deblurring is performed by using a maximum likelihood estimation algorithm.

9. The attitude estimation method for an on-orbit three-dimensional space object according to claim 1, a specific implementation manner of (B3) comprises:
(B3.1) traversing the entire geometrical feature library SMF, and calculating Euclidean distances, represented as D₁, . . . , and D_{K}, between four geometrical features {SG₁,SG₂,SG₃,SG₄} of the image to be tested and each row of vectors in the geometrical feature library SMF, wherein K is a quantity of the multi-viewpoint characteristic views of the object; and
(B3.2) choosing four minimum values D_{S}, Dₜ, Dᵤ, and Dᵥ from the Euclidean distances D₁, . . . , and D_{K}, and calculating an arithmetic mean of four object attitudes corresponding to the four minimum values, wherein the arithmetic mean is an object attitude in the image to be tested.

10. An attitude estimation system for an on-orbit three-dimensional space object, comprising an offline feature library construction module and an online attitude estimation module, wherein
the offline feature library construction module specifically comprises:
a first sub-module, configured to acquire, according to a space object three-dimensional model, multi-viewpoint characteristic views of the object for characterizing various attitudes of the space object; and
a second sub-module, configured to extract geometrical features from each space object multi-viewpoint characteristic view to form a geometrical feature library, wherein the geometrical features comprise an object main body height-width ratio T_{i,1}, an object longitudinal symmetry T_{i,2}, an object horizontal symmetry T_{i,3}, and an object main-axis inclination angle T_{i,4}, wherein the object main body height-width ratio T_{i,1} refers to a height-width ratio of an minimum bounding rectangle of the object; the object longitudinal symmetry T_{i,2} refers to a ratio of an area of the upper-half portion of the object to an area of the lower-half portion of the object within a rectangular region enclosed by the minimum bounding rectangle of the object; the object horizontal symmetry T_{i,3} refers to a ratio of an area of the left-half portion of the object to an area of the right-half portion of the object within the rectangular region enclosed by the minimum bounding rectangle of the object; and the object main-axis inclination angle T_{i,4} refers to an included angle between an object cylinder-body main axis and a view horizontal direction of a characteristic view; and
the online attitude estimation module specifically comprises:
a third sub-module, configured to preprocess an on-orbit space object image to be tested;
a fourth sub-module, configured to extract features from the image to be tested after preprocessing, wherein the features are the same as the features extracted by the second sub-module; and
a fifth sub-module, configured to match the features extracted from the image to be tested in the geometrical feature library, wherein a space object attitude characterized by a characteristic view corresponding to a matching result is an object attitude in the image to be tested.
